(19) United States
(12) Patent Application Publication
(10) Pub. No.: US 2022/0166210 A1
(43) Pub. Date: May 26, 2022

(54) SOLID STATE CIRCUIT BREAKER, METHOD FOR OPERATING SAME, AND CONTROL APPARATUS OF SOLID STATE CIRCUIT BREAKER

(71) Applicant: Siemens Aktiengesellschaft, Muenchen (DE)

(72) Inventors: Feng DU, Shanghai (CN); Wei Gang CHEN, Shanghai (CN)

(73) Assignee: Siemens Aktiengesellschaft, Muenchen (DE)

(21) Appl. No.: 17/598,402

(22) PCT Filed: Mar. 29, 2019
(86) PCT No.: PCT/CN2019/080554

§ 371 Date: Sep. 27, 2021

(51) Int. Cl. H02H 7/00; H02H 3/10; H02H 3/087; H02H 3/093

(52) U.S. Cl. CPC H02H 7/008; H02H 3/0935; H02H 3/087; H02H 3/10

(57) ABSTRACT

A method for operating a solid state circuit breaker includes obtaining information about a maximum breaking current value, obtaining a present current value detected within a present sampling time period and a previous current value detected within a previous sampling time period, the previous sampling period being before the present sampling time period, determining a predicted current value within a next sampling time period based on the present current value, the previous current value, and duration of the sampling time period, the next sampling period being after the present sampling time period, determining whether the predicted current value is greater than the maximum breaking current value of the solid state circuit breaker, and controlling the solid state circuit breaker to disconnect a circuit in which the solid state circuit breaker resides upon the predicted current value being greater than the maximum breaking current value.

### PRIORITY STATEMENT

This application is the national phase under 35 U.S.C. § 371 of PCT International Application No. PCT/CN2019/080554 which has an International filing date of Mar. 29, 2019, which designated the United States of America, the entire contents of which are hereby incorporated herein by reference.

### BACKGROUND

### Technical Field

This application relates to the circuit control field such as solid state circuit breakers, methods for operating the same, and control apparatuses of a solid state circuit breaker.

### Related Art

A solid state circuit breaker is applied to a DC power system, and has an advantage of fast response to a failure in a circuit. However, a fault current in a circuit may have a fast current value growth speed, bringing a challenge to a circuit protection solution based on the solid state circuit breaker.

The solid state circuit breaker has a threshold of a maximum breaking current, and a current flowing through the solid state circuit breaker is limited.

### SUMMARY

If the fault current exceeds the threshold of the maximum breaking current, the solid state circuit breaker may be damaged. For example, within a signal sampling period of the solid state circuit breaker, if the current flowing through the solid state circuit breaker exceeds the threshold, the solid state circuit breaker may be damaged. In addition, if it is hoped to implement selective protection on the circuit, a circuit breaker of an upstream circuit may disconnect the circuit after waiting for a period of time. If within the period of time, the fault current is greater than a current that can be borne by a semiconductor device in the circuit, the semiconductor device may be damaged.

In addition, when a failure occurs, the current may increase fast within a short period of time to exceed the threshold of the maximum breaking current of the solid state circuit breaker. This period of time is even shorter than a sampling period of the solid state circuit breaker, and the solid state circuit breaker cannot disconnect the circuit in time, causing damage to the solid state circuit breaker.

Embodiments of this application provide a solid state circuit breaker, a method for operating the same, and a control apparatus of a solid state circuit breaker, to at least increase protection of the solid state circuit breaker and components in a circuit cannot be effectively protected when a failure occurs in the circuit.

According to another example embodiment of this application, a method for operating a solid state circuit breaker is provided, including obtaining information about a maximum breaking current value of the solid state circuit breaker; obtaining a present current value detected within a present sampling time period and a previous current value detected within a previous sampling time period, the previous sampling period being before the present sampling time period; determining a predicted current value within a next sampling time period based on the present current value, the previous current value, and duration of the sampling time period, the next sampling period being after the present sampling time period; determining whether the predicted current value is greater than the maximum breaking current value of the solid state circuit breaker; and controlling the solid state circuit breaker to disconnect a circuit in which the solid state circuit breaker resides upon the predicted current value being greater than the maximum breaking current value.

Prediction of the current can be performed before the current exceeds the maximum breaking current value reaches the solid state circuit breaker, so that the solid state circuit breaker disconnects the circuit in time, thereby protecting the solid state circuit breaker from being damaged by a fault current.

According to an embodiment of this application, the determining a predicted current value within a next sampling time period after the present sampling time period includes determining a variation of current value within the next sampling time period based on the present current value, the previous current value, and the duration of the sampling time period; and determining the predicted current value based on the present current value and the variation.

A predicted value of a coming current is predicted according to the current detection of the solid state circuit breaker.

According to an embodiment of this application, the determining the variation of current value within the next sampling time period is based on a product of a first order derivative of a respective present current value and the duration of the sampling time period.

The variation of a current value of the coming current relative to the current value of the present current is specifically calculated.

According to an embodiment of this application, the determining the predicted current value within the next sampling time period uses the following formula: ipredicted=i(tn)+i′(tn)×ΔT, where ipredicted represents the predicted current value, i(tn) represents the present current value detected within the present sampling time period, i′(tn) represents a first order derivative of the present current value, ΔT represents a respective sampling time period, and i′(tn)×ΔT represents the variation of the current value within the next sampling time period.

The current value of the coming current is specifically calculated, to determine whether the current flowing through the solid state circuit breaker exceeds a maximum breaking current.

According to an embodiment of this application, the first order derivative of the present current value is determined by using the following formula: i′(tn)=(i(tn)−i(tn−1))/ΔT, where i(tn−1) represents the previous current value detected within the previous sampling time period.

A variation trend of the current is predicted according to the current value obtained by the solid state circuit breaker through sampling.

According to another example embodiment of this application, a threshold receiving unit, configured to obtain information about a maximum breaking current value of the solid state circuit breaker; a current detection unit, configured to obtain a present current value detected within a present sampling time period and a previous current value detected within a previous sampling time period, the previous sampling period being before the present sampling time period; a prediction unit configured to determine a predicted current value within a next sampling time period after the present sampling time period based on the present current value, the previous current value, and duration of the sampling time period, the next sampling period being after the previous sampling time period; a determining unit, configured to determine whether the predicted current value is greater than the maximum breaking current value of the solid state circuit breaker; and a breaking unit, configured control the solid state circuit breaker to disconnect the circuit in which the solid state circuit breaker resides upon the predicted current value being greater than the maximum breaking current value.

Prediction of the current can be performed before the current exceeds the maximum breaking current value reaches the solid state circuit breaker, so that the solid state circuit breaker disconnects the circuit in time, thereby protecting the solid state circuit breaker from being damaged by a fault current.

According to another example embodiment of this application, comprising: a control apparatus, the control apparatus including a threshold receiving unit, configured to obtain information about a maximum breaking current value of the solid state circuit breaker; a current detection unit, configured to obtain a present current value detected within a present sampling time period and a previous current value detected within a previous sampling time period, the previous sampling period being before the present sampling time period; a prediction unit, configured to determine a predicted current value within a next sampling time period after the present sampling time period based on the present current value, the previous current value, and duration of the sampling time period; a determining unit, configured to determine whether the predicted current value is greater than the maximum breaking current value of the solid state circuit breaker; and a breaking unit configured to control the solid state circuit breaker to disconnect the circuit in which the solid state circuit breaker resides upon the predicted current value being greater than the maximum breaking current value.

Prediction of the current can be performed before the current exceeds the maximum breaking current value reaches the solid state circuit breaker, so that the solid state circuit breaker disconnects the circuit in time, thereby protecting the solid state circuit breaker from being damaged by a fault current.

According to an embodiment of this application, the solid state circuit breaker further includes a current limiter configured to limit an increasing rate of the current flowing through the solid state circuit breaker.

A variation rate of the current is limited to avoid/reduce the likelihood of damaging the solid state circuit breaker.

According to an embodiment of this application, wherein the current limiting component includes an iron core; and a first inductor and a second inductor wrapped on the iron core around an axis of the iron core, where current directions in the first inductor and the second inductor are opposite.

Even though the current limiting component is not saturated in a magnetic field in a case of a large DC current, the current limiting effect is improved.

In the embodiments of this application, the technical solutions in which the current flowing through the solid state circuit breaker is sampled, whether the predicted current value of the current that is about to reach the solid state circuit breaker exceeds the threshold is predicted, and the circuit is disconnected when the predicted current value exceeds the threshold are provided, to at least resolve the technical problem of how to prevent the fault current from damaging the device in the circuit, thereby implementing the technical effect of effectively protecting the safety of the circuit device.

### BRIEF DESCRIPTION OF THE DRAWINGS

The accompanying drawings described herein are used for provide further understanding of this application, and form a part of this application. Example embodiments of this application and descriptions of the example embodiments are used for explaining this application, and do not form an improper limitation to this application. In the accompanying drawings:

FIG. 1 is a schematic diagram of a circuit system in which a solid state circuit breaker is used to perform a circuit protection solution according to an embodiment of this application;

FIG. 2 is a flowchart of a method for operating a solid state circuit breaker according to an embodiment of this application;

FIG. 3 is a flowchart of a method according to an embodiment of this application;

FIG. 4 is a schematic diagram of another circuit system in which a solid state circuit breaker is used to perform a circuit protection solution;

FIG. 5 is a schematic diagram of a control apparatus of a solid state circuit breaker according to an embodiment of this application;

FIG. 6 is a schematic diagram of a solid state circuit breaker according to an embodiment of this application;

FIG. 7 is a schematic diagram of a solid state circuit breaker according to an example embodiment of this application; and

FIG. 8 is a schematic diagram of a current limiting component according to an example embodiment of this application.

### DESCRIPTIONS OF NUMBERS OF THE ACCOMPANYING DRAWINGS

100. AC power supply;
110, 120. AC/DC converters;
130. Battery power supply;
140. PV power supply;
150. DC bus;
PD-1.1˜PD-1.4, PD-2.1˜PD-2.7. Solid state circuit breakers;
111, 113, 121, 123, 131, 133, 141. Loads;
F1˜F4. Positions at which a failure may occur;
S201˜S211, S301˜S303. Steps;
5. Control apparatus;
501. Sampling time period receiving unit;
503. Threshold receiving unit;
505. Current detection unit;
507. Prediction unit;
509. Determining unit;
511. Breaking unit;
7. Solid state circuit breaker;
9. Current limiting component;
91. Iron core;
L+. First inductor; and
L−. Second inductor.

### DETAILED DESCRIPTION

To make a person skilled in the art understand the solutions in this application better, the following describes the technical solutions in the embodiments of this application with reference to the accompanying drawings in the embodiments of this application. The described embodiments are merely examples. All other embodiments obtained by a person skilled in the art based on the embodiments of the present application without creative efforts shall fall within the protection scope of the present application.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved. In addition, the terms “include”, “comprise”, and any variants thereof are intended to cover a non-exclusive inclusion. For example, a process, method, system, product, or device that includes a series of steps or modules or components is not limited to the steps or modules or units that are clearly listed, but may include other steps or modules or units that are not clearly listed or that are inherent to the process, method, product, or device.

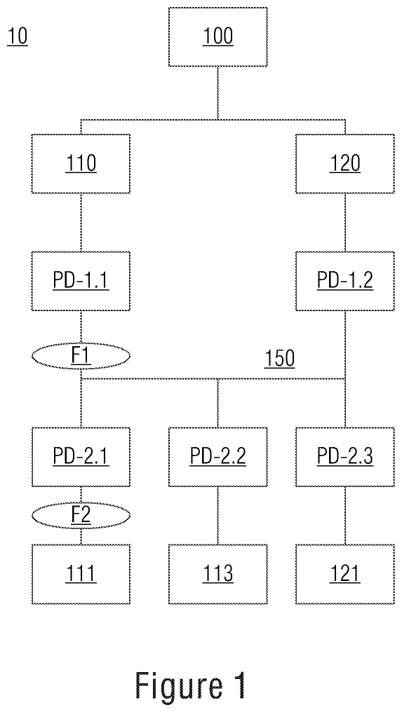

FIG. 1 is a schematic diagram of a circuit system in which a solid state circuit breaker is used to perform a circuit protection solution according to an example embodiment. As shown in FIG. 1, a circuit 10 includes an AC power supply 100, an AC/DC converter 110, an AC/DC converter 120, a load 111, a load 113, and a load 121. The AC/DC converter 110 and AC/DC converter 120 are connected to the load 111, the load 113, and the load 121 by using a DC bus 150. A solid state circuit breaker PD-1.1 is connected in series between the AC/DC converter 110 and the DC bus 150, a solid state circuit breaker PD-1.2 is connected in series between the AC/DC converter 120 and the DC bus 150, and a solid state circuit breaker PD-2.1, a solid state circuit breaker PD-2.2, and a solid state circuit breaker PD-2.3 are respectively connected in series between the load 111 and the DC bus 150, between the load 113 and the DC bus 150, and between the load 121 and the DC bus 150. F1 and F2 respectively represent a position at which a failure may occur.

In the circuit system shown in FIG. 1, if a failure occurs at F1, a safe breaking current threshold of the solid state circuit breaker PD-1.1 is 4300 A, a sampling period of the solid state circuit breaker PD-1.1 is 10 μs, and an actual fault current is 5255 A. In this case, if the actual fault current is greater than the safe breaking current threshold of the solid state circuit breaker PD-1.1, the solid state circuit breaker PD-1.1 may be damaged. If there is no breaking of the solid state circuit breaker PD-1.1, the peak of the fault current may reach up to 16 kA.

In the circuit system shown in FIG. 1, if a failure occurs at F2, when there is no breaking of the solid state circuit breaker, the peak of the fault current may reach 10 kA. A normal working current of the solid state circuit breaker PD-2.1 is 98 A, and a threshold current causing its damage is 490 A. After the failure occurs, within a sampling period 10 μs of the solid state circuit breaker PD-2.1, the current value rises to 3686 A, which exceeds the threshold that damages the solid state circuit breaker PD-2.1. It means that even though the solid state circuit breaker PD-2.1 detects the failure and breaks the circuit at once, there exists a high risk of damaging the solid state circuit breaker PD-2.1 itself.

To protect the solid state circuit breaker from being damaged by the fault current, a threshold of a current increasing rate may be set, and if a current increasing rate exceeds the threshold of the current increasing rate, the solid state circuit breaker is operated to perform breaking. However, the actual increasing rate of the current depends on parameters in the system circuit, so that it is difficult for the complex system to determine a suitable threshold of the current increasing rate. In addition, a high-speed sampling processing solution may be designed based on an ultra fast analog circuit. However, this may increase the system complexity and significantly increase the costs of a drive circuit and a signal processing circuit.

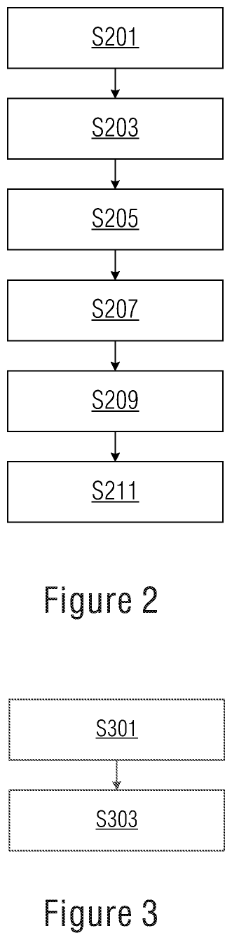

According to an embodiment of this application, a method for operating a solid state circuit breaker is provided. FIG. 2 is a flowchart of a method for operating a solid state circuit breaker according to an embodiment of this application. As shown in FIG. 2, the method for operating a solid state circuit breaker includes: S201. Obtain information about a sampling time period of a solid state circuit breaker, where the solid state circuit breaker detects a current value of a current flowing through the solid state circuit breaker within one or more sampling time periods. For example, if the solid state circuit breaker has a sampling period 10 μs, the solid state circuit breaker obtains, every 10 μs, a current value of a sampling current for the current flowing through the solid state circuit breaker, and the 10 μs is used as the information about the sampling time period of the solid state circuit breaker. S203. Obtain information about a maximum breaking current value of the solid state circuit breaker. The maximum breaking current value of the solid state circuit breaker represents that if the current flowing through the solid state circuit breaker reaches the value, the solid state circuit breaker may perform the operation of the breaking circuit, to disconnect the circuit, to prevent a fault current from flowing to the components. If the fault current exceeds the value and flows through the components, the components may be damaged. S205. Obtain a present current value detected within a present sampling time period and a previous current value detected within a previous sampling time period before the present sampling time period. The solid state circuit breaker detects current values within the sampling periods, and within each present sampling period, to predict the current in the next sampling period, the current values detected within the present sampling period and the previous sampling period are obtained. S207. Determine a predicted current value within a next sampling time period after the present sampling time period according to the present current value, the previous current value, and duration of the sampling time period. The predicted current value can be calculated based on the current values detected within the present sampling period and the previous sampling period and duration of the sampling periods, and then, in S209, whether the predicted current value is greater than the maximum breaking current value of the solid state circuit breaker is determined. In S211, if the predicted current value is greater than the maximum breaking current value, the solid state circuit breaker is made to disconnect the circuit in which the solid state circuit breaker resides. It should be understood that, the steps of obtaining information about a sampling time period of a solid state circuit breaker and obtaining information about a maximum breaking current value of the solid state circuit breaker are not necessarily performed according to a sequential order, provided that the sampling time period of the solid state circuit breaker and the maximum breaking current value of the solid state circuit breaker can be determined to predict the predicted current value of the next sampling period. Prediction of a current can be performed before the current exceeds the maximum breaking current value reaches the solid state circuit breaker, so that the solid state circuit breaker can disconnect the circuit in time, thereby protecting the solid state circuit breaker from being damaged by the fault current.

FIG. 3 is a flowchart of a method according to an embodiment of this application. As shown in FIG. 3, the determining a predicted current value within a next sampling time period after the present sampling time period includes: S301. Determine a variation of the current value within the next sampling time period according to the present current value, the previous current value, and the duration of the sampling time period. S303. Determine the predicted current value according to the present current value and the variation. If the present current value and the variation within the next sampling time period are known, the present current value and the variation can be combined to predict a current value of a coming current within the next sampling time period. The predicted value of the coming current can be predicted according to the current detection of the solid state circuit breaker, so that the solid state circuit breaker can perform the operation of disconnecting the circuit in advance, to prevent an excessive current from flowing through the components.

According to another embodiment of this application, the coming current within the next sampling time period is predicted based on system parameters in the circuit. For example, the peak of the coming current within the next sampling time period is estimated based on system inductance, system impedance, or the like that can be obtained by sampling current values and/or voltage information. If the coming current within the next sampling time period predicted based on the system parameters in the circuit exceeds the maximum breaking current value, the solid state circuit breaker is made to perform the operation of the breaking circuit.

According to an embodiment of this application, the variation of the current value within the next sampling time period is determined according to the product of the first order derivative of the present current value and the duration of the sampling time period. The first order derivative of the current value may represent a variation trend of the current, and the variation of the change of the current value within the next sampling time period can be estimated in combination with the duration of the sampling time period. After the variation is determined, the predicted current value of the next sampling time period can be determined in combination with the present current value.

According to an embodiment of this application, the predicted current value within the next sampling time period is determined by using the following formula: ipredicted=i(tn)+i′(tn)×ΔT, where ipredicted represents the predicted current value, i(tn) represents the present current value detected within the present sampling time period, i′(tn) represents the first order derivative of the present current value, ΔT represents the sampling time period, and i′(tn)×ΔT represents the variation of the current value within the next sampling time period. The current value of the coming current is specifically calculated, to determine whether the current flowing through the solid state circuit breaker exceeds the maximum breaking current.

According to an embodiment of this application, the first order derivative of the present current value is determined by using the following formula: i′(tn)=(i(tn)−i(tn−1))/ΔT, where i(tn−1) represents the previous current value detected within the previous sampling time period. The variation of a current value of the coming current relative to the current value of the present current is specifically calculated. A variation trend of the current is predicted according to the current value obtained by the solid state circuit breaker through sampling.

For example, referring to FIG. 1, by using the method for controlling a solid state circuit breaker as described above, the safe breaking current threshold (e.g., a maximum breaking current value) of the solid state circuit breaker PD-1.1 is 4300 A, and the sampling period (sampling time period) of the solid state circuit breaker PD-1.1 is 10 μs. The foregoing information about the solid state circuit breaker PD-1.1 is obtained, and the solid state circuit breaker PD-1.1 obtains the current value within each sampling period. If a failure occurs at F1, the variation trend (that is, the first order derivative of the present current value) of the current value is determined according to (the difference between the current values within the present sampling period and the previous sampling period)/(the duration 10 μs of the sampling period), and after the variation trend is determined, for the next sampling period, the predicted current value within the next sampling period is determined according to (the present current value+the variation trendxthe duration of the next sampling period). For each present sampling period, if it is determined that the predicted current value within the next sampling period exceeds 4300 A, the solid state circuit breaker PD-1.1 is controlled to perform the operation of the breaking circuit. For example, in this embodiment, the predicted current value predicted within the next sampling period exceeds 4300 A, and the solid state circuit breaker PD-1.1 is controlled to perform the operation of the breaking circuit. The current is 3917 A when the breaking is performed, to avoid/reduce the risk of damaging the solid state circuit breaker PD-1.1.

For example, referring to FIG. 1, by using the method for controlling a solid state circuit breaker as described above, the safe breaking current threshold (e.g., maximum breaking current value) of the solid state circuit breaker PD-2.1 is 490 A, and the sampling period (sampling time period) of the solid state circuit breaker PD-2.1 is 10 μs. The foregoing information about the solid state circuit breaker PD-2.1 is obtained, and the solid state circuit breaker PD-2.1 obtains the current value within each sampling period. If a failure occurs at F2, the variation trend (that is, the first order derivative of the present current value) of the current value is determined according to (the difference between the current values within the present sampling period and the previous sampling period)/(the duration 10 μs of the sampling period), and after the variation trend is determined, for the next sampling period, the predicted current value within the next sampling period is determined according to (the present current value+the variation trendxthe duration of the next sampling period). For each present sampling period, if it is determined that the predicted current value within the next sampling period exceeds 490 A, the solid state circuit breaker PD-2.1 is controlled to perform the operation of the breaking circuit. For example, in this embodiment, the predicted current value predicted within the next sampling period exceeds 490 A, and the solid state circuit breaker PD-2.1 is controlled to perform the operation of the breaking circuit. The current is 485 A when the breaking is performed, to avoid/reduce the risk of damaging the solid state circuit breaker PD-2.1.

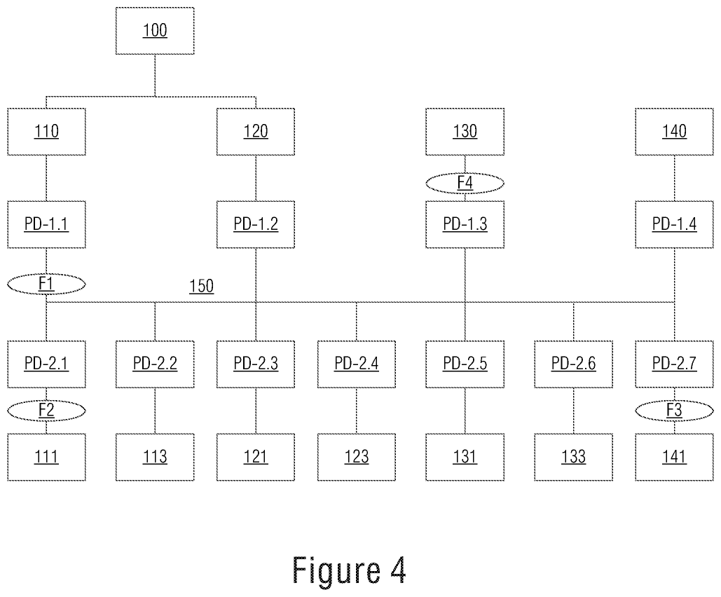

FIG. 4 is a schematic diagram of another circuit system in which a solid state circuit breaker is used to perform a circuit protection solution according to an example embodiment. As shown in FIG. 4, compared with the circuit system in which the solid state circuit breaker is used to perform the circuit protection solution shown in FIG. 1, another circuit system in which the solid state circuit breaker is used to perform the circuit protection solution additionally has a battery power supply 130, a PV power supply 140, a load 123, a load 131, a load 133, a load 141, a solid state circuit breaker PD-1.3, a solid state circuit breaker PD-1.4, a solid state circuit breaker PD-2.4, a solid state circuit breaker PD-2.5, a solid state circuit breaker PD-2.6, and a solid state circuit breaker PD-2.7. Other elements in FIG. 4 are the same as those in FIG. 1. F3 and F4 represent positions at which a failure may occur in the circuit. If the failure occurs at F3, for a method for controlling a solid state circuit breaker, refer to the method for controlling the solid state circuit breaker PD-2.1 when a failure occurs at F2 in FIG. 1. If the failure occurs at F4, for a method for controlling a solid state circuit breaker, refer to the method for controlling the solid state circuit breaker PD-1.1 when a failure occurs at F1 in FIG. 1. The method for controlling a solid state circuit breaker is the same as previously described, and is not described herein again.

The foregoing method for controlling a solid state circuit breaker is used to avoid/reduce the likelihood of damaging the solid state circuit breaker when the fault current is increased and exceeds the threshold of the maximum breaking current or the safe working current of the solid state circuit breaker.

According to an embodiment of this application, a control apparatus of a solid state circuit breaker is further provided. FIG. 5 is a schematic diagram of a control apparatus of a solid state circuit breaker according to an embodiment of this application. As shown in FIG. 5, a control apparatus 5 of a solid state circuit breaker includes: a sampling time period receiving unit 501, configured to obtain information about a sampling time period of a solid state circuit breaker, where the solid state circuit breaker detects a current value of a current flowing through the solid state circuit breaker within one or more sampling time periods; a threshold receiving unit 503, configured to obtain information about a maximum breaking current value of the solid state circuit breaker; a current detection unit 505, configured to obtain a present current value detected within a present sampling time period and a previous current value detected within a previous sampling time period before the present sampling time period; a prediction unit 507, configured to determine a predicted current value within a next sampling time period after the present sampling time period according to the present current value, the previous current value, and duration of the sampling time period; a determining unit 509, configured to determine whether the predicted current value is greater than the maximum breaking current value of the solid state circuit breaker; and a breaking unit 511, configured to make, if the predicted current value is greater than the maximum breaking current value, the solid state circuit breaker disconnect the circuit in which the solid state circuit breaker resides. Prediction of the current can be performed before the current exceeds the maximum breaking current value reaches the solid state circuit breaker, so that the solid state circuit breaker disconnects the circuit in time, thereby protecting the solid state circuit breaker and the components from being damaged by a fault current. A control method of the control apparatus of a solid state circuit breaker according to this embodiment of this application is the same as that in the foregoing, and is not described herein again.

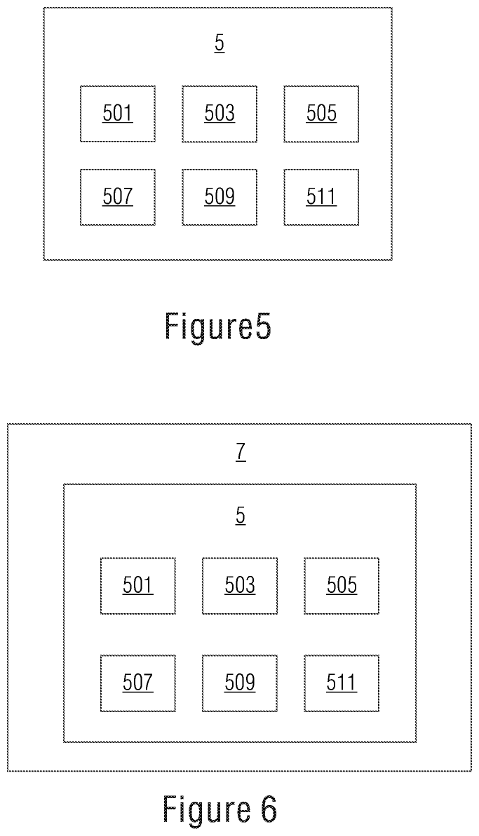

According to an embodiment of this application, a solid state circuit breaker is further provided. FIG. 6 is a schematic diagram of a solid state circuit breaker according to an embodiment of this application. As shown in FIG. 6, the solid state circuit breaker 7 includes a control apparatus 5, and the control apparatus includes: a sampling time period receiving unit 501, configured to obtain information about a sampling time period of a solid state circuit breaker, where the solid state circuit breaker detects a current value of a current flowing through the solid state circuit breaker within one or more sampling time periods; a threshold receiving unit 503, configured to obtain information about a maximum breaking current value of the solid state circuit breaker; a current detection unit 505, configured to obtain a present current value detected within a present sampling time period and a previous current value detected within a previous sampling time period before the present sampling time period; a prediction unit 507, configured to determine a predicted current value within a next sampling time period after the present sampling time period according to the present current value, the previous current value, and duration of the sampling time period; a determining unit 509, configured to determine whether the predicted current value is greater than the maximum breaking current value of the solid state circuit breaker; and a breaking unit 511, configured to make, if the predicted current value is greater than the maximum breaking current value, the solid state circuit breaker disconnect the circuit in which the solid state circuit breaker resides. Prediction of the current can be performed before the current exceeding the maximum breaking current value reaches the solid state circuit breaker, so that the solid state circuit breaker disconnects the circuit in time, thereby protecting the solid state circuit breaker and the components from being damaged by a fault current. A control method of the control apparatus of a solid state circuit breaker according to this embodiment of this application is the same as that in the foregoing, and is not described herein again.

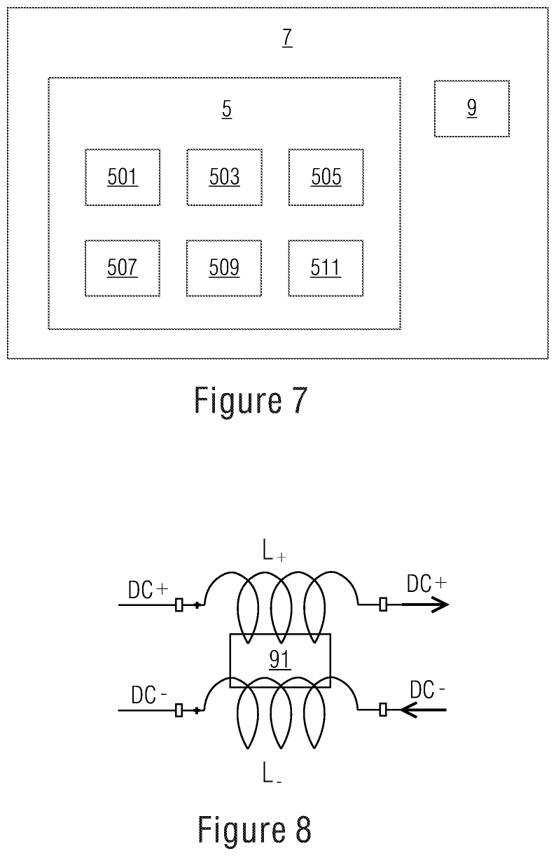

FIG. 7 is a schematic diagram of a solid state circuit breaker according to an example embodiment of this application. According to an example embodiment of this application, the solid state circuit breaker 7 further includes: a current limiting component 9, configured to limit an increasing rate of the current value of the current flowing through the solid state circuit breaker. A variation rate of the current is limited to avoid/reduce the likelihood of damaging the solid state circuit breaker.

FIG. 8 is a schematic diagram of a current limiting component according to an example embodiment of this application. According to an example embodiment of this application, the current limiting component includes: an iron core 91; and a first inductor L+ and a second inductor L-wrapped on the iron core 91 around the axis of the iron core 91, where current directions in the first inductor and the second inductor are opposite. According to an example embodiment of this application, the size of the iron core is relatively small, wraps of the coil is reduced, and an inductance value is based on the high magnetic permeability of the iron core 91. Even though the current limiting component is not saturated in a magnetic field in a case of a large DC current, the current limiting effect is improved.

In the foregoing embodiments of this application, descriptions of the embodiments have different emphases, and as for parts that are not described in detail in one embodiment, reference can be made to the relevant description of the other embodiments.

In this application, the technical effect of operating the safe breaking circuit of the solid state circuit breaker without using complex circuit control is implemented, the control of the breaking circuit is based on the predicted current value, and the increasing rate of the value of the fault current is limited by the current limiting component, to protect the solid state circuit breaker.

In the several embodiments provided in the present application, it should be understood that the disclosed technical content may be implemented in other manners. The described apparatus embodiments are merely examples. For example, the unit or module division may be a logical function division and may be implemented in other manners. For example, a plurality of units or modules or components may be combined or integrated into another system, or some features may be ignored or not performed. In addition, the displayed or discussed mutual couplings or direct couplings or communication connections may be implemented through some interfaces. The indirect couplings or communication connections between the modules or units may be implemented in electronic or other forms.

The units or modules described as separate parts may or may not be physically separate, and the parts displayed as units or modules may or may not be physical units or modules, may be located in one position, or may be distributed on a plurality of network units or modules. A part of or all of the units or modules may be selected according to actual needs to achieve the objectives of the solutions of the embodiments.

In addition, functional units or modules in the embodiments of the present application may be integrated into one processing unit or module, or each of the units or modules may exist alone physically, or two or more units or modules may be integrated into one unit or module. The integrated unit or module may be implemented in a form of hardware, or may be implemented in a form of a software functional unit or module.

If implemented in the form of software functional units and sold or used as an independent product, the integrated units may also be stored in a computer-readable storage medium. Based on such an understanding, the technical solutions of the present application essentially, or the part contributing to the prior art, or all or some of the technical solutions may be implemented in a form of a software product. The computer software product is stored in a storage medium and includes several instructions for instructing a computer device (which may be a personal computer, a server, a network device, or the like) to perform all or some of the steps of the methods described in the embodiments of the present application. The foregoing storage medium includes: any medium that can store program code, such as a USB flash drive, a read-only memory (ROM), a random access memory (RAM), a removable hard disk, a magnetic disk, or an optical disc.

The foregoing descriptions are merely example embodiments of this application, and it should be noted that, a person of ordinary skill in the art may make various improvements and refinements without departing from the spirit of this application. All such modifications and refinements should also be intended to be covered by this application.

1. A method for operating a solid state circuit breaker, comprising:
obtaining information about a maximum breaking current value of the solid state circuit breaker;
obtaining a present current value detected within a present sampling time period and a previous current value detected within a previous sampling time period, the previous sampling period being before the present sampling time period;
determining a predicted current value within a next sampling time period based on the present current value, the previous current value, and duration of the sampling time period, the next sampling period being after the present sampling time period;
determining whether the predicted current value is greater than the maximum breaking current value of the solid state circuit breaker; and
controlling the solid state circuit breaker to disconnect a circuit in which the solid state circuit breaker resides upon the predicted current value being greater than the maximum breaking current value.

2. The method according to claim 1, wherein the determining a predicted current value within a next sampling time period after the present sampling time period comprises:
determining a variation of current value within the next sampling time period based on the present current value, the previous current value, and the duration of the sampling time period; and
determining the predicted current value based on the present current value and the variation.

3. The method according to claim 2, wherein the determining the variation of current value within the next sampling time period is based on a product of a first order derivative of the present current value and the duration of a respective sampling time period.

4. The method according to claim 2, wherein the determining the predicted current value within the next sampling time period uses the following formula:
i_{predicted}=i(tₙ)+i′(tₙ)×ΔT,
wherein i_{predicted} represents the predicted current value, i(tₙ) represents the present current value detected within the present sampling time period, i′(tₙ) represents a first order derivative of the present current value, ΔT represents respective sampling time period, and i′(tₙ)×ΔT represents the variation of the current value within the next sampling time period.

5. The method according to claim 4, wherein the first order derivative of the present current value is determined by using the following formula:
i′(tₙ)=(i(tₙ)−(tₙ₋₁))/ΔT,
wherein i(tₙ₋₁) represents the previous current value detected within the previous sampling time period.

6. A control apparatus of a solid state circuit breaker, comprising:
a threshold receiving unit configured to obtain information about a maximum breaking current value of the solid state circuit breaker;
a current detection unit, configured to obtain a present current value detected within a present sampling time period and a previous current value detected within a previous sampling time period, the previous sampling period being before the present sampling time period;
a prediction unit configured to determine a predicted current value within a next sampling time period after the present sampling time period based on the present current value, the previous current value, and duration of the sampling time period, she next sampling period being after the previous sampling time period;
a determining unit configured to determine whether the predicted current value is greater than the maximum breaking current value of the solid state circuit breaker; and
a breaking unit configured to control the solid state circuit breaker to disconnect a circuit in which the solid state circuit breaker resides upon the predicted current value being greater than the maximum breaking current value.

7. A solid state circuit breaker comprising:
a control apparatus, the control apparatus including,
a threshold receiving unit configured to obtain information about a maximum breaking current value of the solid state circuit breaker;
a current detection unit configured to obtain a present current value detected within a present sampling time period and a previous current value detected within a previous sampling time period, the previous sampling period being before the present sampling time period;
a prediction unit configured to determine a predicted current value within a next sampling time period after the present sampling time period based on the present current value, the previous current value, and duration of the sampling time period;
a determining unit, configured to determine whether the predicted current value is greater than the maximum breaking current value of the solid state circuit breaker; and
a breaking unit configured to control the solid state circuit breaker to disconnect a circuit in which the solid state circuit breaker resides upon the predicted current value being greater than the maximum breaking current value.

8. The solid state circuit breaker according to claim 7, further comprising:
a current limiter configured to limit an increasing rate of the current flowing through the solid state circuit breaker.

9. The solid state circuit breaker according to claim 8, wherein the current limiting component comprises:
an iron core; and
a first inductor and a second inductor wrapped on the iron core around an axis of the iron core, wherein current directions in the first inductor and the second inductor are opposite.

10. The method according to claim 3, wherein the determining the predicted current value within the next sampling time period uses the following formula:
i_{predicted}=i(tₙ)+i′(tₙ)×ΔT,
wherein i_{predicted} represents the predicted current value, i(tₙ) represents the present current value detected within the present sampling time period, i′(tₙ) represents a first order derivative of the present current value, ΔT represents a respective sampling time period, and i′(tₙ)×ΔT represents the variation of the current value within the next sampling time period.
